(19) United States
(12) Patent Application Publication
(10) Pub. No.: US 2018/0159965 A1
(43) Pub. Date: Jun. 7, 2018

(54) NETWORKED TRANSPORT LAYER SOCKET

(71) Applicants: Andrea Francini, Chapel Hill, NC (US); Joseph D. Beshay, Richardson, TX (US)

(72) Inventors: Andrea Francini, Chapel Hill, NC (US); Joseph D. Beshay, Richardson, TX (US)

(73) Assignee: Alcatel Lucent, Boulogne-Billancourt (FR)

(21) Appl. No.: 15/368,540

(22) Filed: Dec. 2, 2016

(51) Int. Cl. H04L 29/06; H04L 12/24

(52) U.S. Cl. CPC H04L 69/161; H04L 41/02

(57) ABSTRACT

The present disclosure generally discloses a networked transport layer socket capability. The networked transport layer socket capability, for transport layer connection of a communication device attached to a network access device, moves the transport layer connection endpoint of the transport layer connection of the communication device (which also may be referred to as a client transport layer socket of the transport layer connection of the communication device) from the communication device into the network access device. The application client at the application layer of the communication device, rather than communicating with the client transport layer socket of the transport layer of the communication device internally within the communication device, communicates with the client transport layer socket of the transport layer of the communication device, which is provided within the network access device for the communication device, via a communication path between the communication device and the network access device.

### TECHNICAL FIELD

The present disclosure relates generally to communication systems and, more particularly but not exclusively, to transport layer connections in communication systems.

### BACKGROUND

In a device that is capable of communicating via a communication network, such as the Internet, communication by the device is typically supported using a communication protocol stack that typically includes an application layer, a transport layer, a network layer, a link layer, and a physical layer.

### SUMMARY

The present disclosure generally discloses a networked transport layer socket capability.

In at least some embodiments, a communication device is provided. The communication device includes a processor and a memory communicatively connected to the processor. The processor is configured to run a communication protocol stack. The communication protocol stack includes an application layer, a socket application programming interface (API), a link layer, and a physical layer. The socket API is configured to support communication of data, between the application layer and a networked transport layer socket hosted on a network access device for the communication device, via the link layer and the physical layer.

In at least some embodiments, a method for use by a communication device is provided. The method includes running, by a processor of the communication device, a communication protocol stack. The communication protocol stack includes an application layer, a socket application programming interface (API), a link layer, and a physical layer. The method includes communicating data, by the socket API between the application layer and a networked transport layer socket hosted on a network access device for the communication device, via the link layer and the physical layer.

In at least some embodiments, a network access device is provided. The network access device includes a processor and a memory communicatively connected to the processor. The processor is configured to run a communication protocol stack. The communication protocol stack includes a transport layer, a socket application programming interface (API), a link layer, and a physical layer. The transport layer is configured to host a networked transport layer socket for a communication device having an application layer. The socket API is configured to support communication of data, between the networked transport layer socket for the communication device and the application layer of the communication device, via the link layer and the physical layer.

In at least some embodiments, a method for use by a network access device is provided. The method includes running, by a processor of the network access device, a communication protocol stack. The communication protocol stack includes a transport layer, a socket application programming interface (API), a link layer, and a physical layer. The transport layer hosts a networked transport layer socket for a communication device having an application layer. The method includes communicating data, by the socket API between the networked transport layer socket for the communication device and the application layer of the communication device, via the link layer and the physical layer.

### BRIEF DESCRIPTION OF THE DRAWINGS

The teachings herein can be readily understood by considering the following detailed description in conjunction with the accompanying drawings, in which:

FIG. 1 depicts a communication system configured to support use of a client transport layer socket to support communication between a mobile host device and a server via a wireless access device;

FIG. 2A depicts the communication protocol stacks of the mobile host device, the wireless access device, and the server of the communication system of FIG. 1 when the client transport layer socket of the mobile host device is provided on the mobile host device;

FIG. 2B depicts the communication protocol stacks of the mobile host device, the wireless access device, and the server of the communication system of FIG. 1 when the client transport layer socket of the mobile host device is networked on the wireless access device;

FIG. 3 depicts an embodiment of a method for use by the mobile host device of the communication system of FIG. 1;

FIG. 4 depicts an embodiment of a method for use by the wireless access device of the communication system of FIG. 1; and

FIG. 5 depicts a high-level block diagram of a computer suitable for use in performing various functions presented herein.

To facilitate understanding, identical reference numerals have been used, where possible, to designate identical elements that are common to the figures.

### DETAILED DESCRIPTION

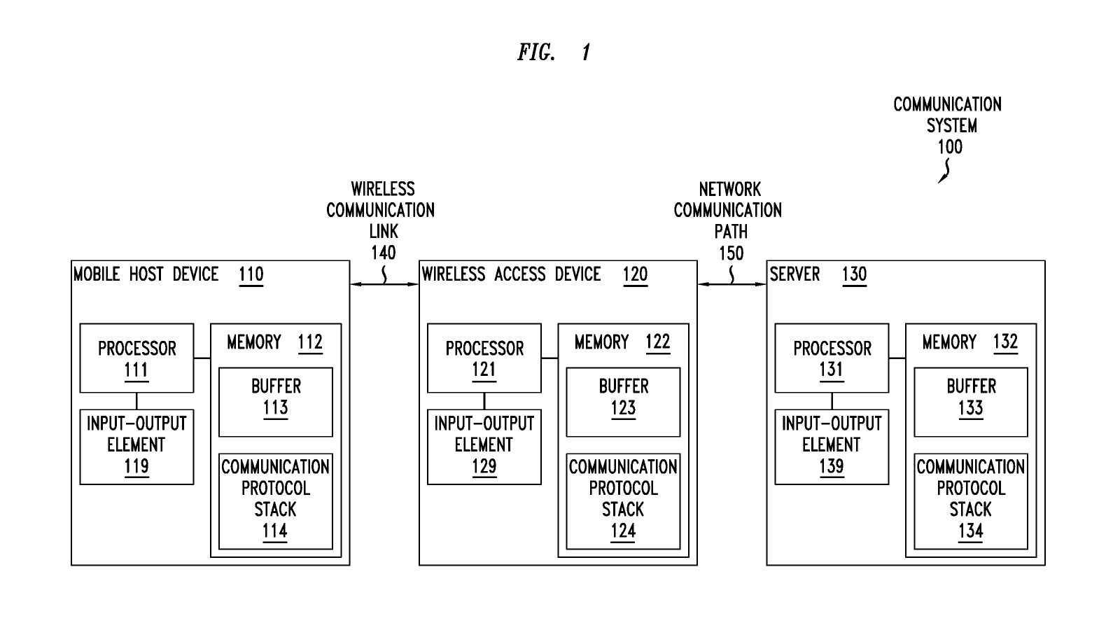

The present disclosure generally discloses a networked transport layer socket capability. The networked transport layer socket capability, for transport layer connection of a communication device (e.g., a mobile host device or other communication device) attached to a network access device (e.g., a wireless access device, a wireline access device, or the like), moves the transport layer connection endpoint of the transport layer connection of the communication device (which also may be referred to herein as a client transport layer socket of the transport layer connection of the communication device) from the communication device into the network access device. The application client at the application layer of the communication device, rather than communicating with the client transport layer socket of the transport layer of the communication device internally within the communication device, communicates with the client transport layer socket of the transport layer of the communication device, which is provided within the network access device for the communication device, via a communication path (e.g., a network communication link, such as a wireless link or a wired link) between the communication device and the network access device. The application client at the application layer of the communication device communicates with the client transport layer socket of the transport layer of the communication device, which is provided within the network access device for the communication device, based on splitting of a client socket Application Programming Interface (API) of the communication device across the communication device and the network access device. The client socket API of the communication device is split across the communication device and the network access device by providing a first client socket API endpoint of the client API socket (also referred to herein as “client socket API—north”) on the communication device and providing a second client socket API endpoint of the client API socket (also referred to herein as “client socket API—south”) on the network access device. The client socket API—north and client socket API—south, together, operate to provide the client socket API which is configured to facilitate communication between the application client at the application layer of the communication device and the client transport layer socket of the transport layer of the communication device which is networked within the network access device for the communication device. The client socket API endpoints communicate via a client socket API connection between the client socket API endpoints. The client socket API connection between the client socket API endpoints is supported by a link layer connection between a link layer that is available on the communication device and a link layer that is available on the network access device. The client socket API that is supported by the communication device and the network access device is configured to support communication, between the application client at the application layer of the communication device and the client transport layer socket of the transport layer of the communication device which is networked within the network access device for the communication device, based on the client socket API connection and the underlying link layer connection. The placement of the client transport layer socket of the transport layer connection of the communication device within the network access device, rather than within the communication device, may be transparent to the application layer of the communication device (e.g., the application layer at the communication device uses the client socket API without knowing that the client transport layer socket is not co-located within the communication device, but, rather, is hosted within the network access device on behalf of the communication device). The transport layer supported at the network access device may utilize any suitable type of transport layer protocol (e.g., primarily presented herein with respect to use of the Transmission Control Protocol (TCP), however, it will be appreciated that other transport layer protocols (e.g., User Datagram Protocol (UDP) or the like) may be used). The networked transport layer socket capability may be used to eliminate the transmission of transport layer acknowledgments over the communication link between the communication device and the network access device for the transport layer connection since the client transport layer socket of the transport layer connection is provided in the network access device as reliability for the communications between the application client of the communication device and the client transport layer socket of the communication device may be provided by reliability features of the link layer connection used for communication between the application client of the communication device and the client transport layer socket of the communication device via the communication link between the communication device and the network access device. The networked transport layer socket capability may provide various improvements in computer performance in supporting communications between devices of communication networks. It is noted that, although primarily presented herein with respect to embodiments in which the networked transport layer socket capability is used within the context of wireless access by a wireless communication device (e.g., the communication device is a mobile host device, the network access device is a wireless access device, and the network communication link is a wireless communication link), the networked transport layer socket capability also may be used within the context of wireline access by the communication device. It will be appreciated that these and various other embodiments and potential advantages of the networked transport layer socket capability may be further understood by way of reference to the example communication system of FIG. 1.

FIG. 1 depicts a communication system configured to support use of a client transport layer socket to support communication between a mobile host device and a server via a wireless access device.

The communication system 100 includes a mobile host device (MHD) 110, a wireless access device (WAD) 120, and a server 130. The MHD 110 and the WAD 120 are configured to communicate via a wireless communication link 140. The WAD 120 and the server 130 are configured to communicate via a network communication path 150.

The communication system 100 may be provided using various types of underlying wireless technologies and, therefore, the MHD 110 and the WAD 120 may be configured to support various types of underlying wireless technologies (e.g., in terms of the implementation of certain layers of the communication protocol stacks 114 and 124 of the MHD 110 and the WAD 120, respectively). For example, communication system 100 may be provided using cellular wireless technology (e.g., Third Generation (3G) wireless technology, Fourth Generation (4G) wireless technology such as Long Term Evolution (LTE), Fifth Generation (5G) wireless technology, or the like), WiFi, or the like, as well as various combinations thereof. It will be appreciated that the communication system 100 may be provided using other types of underlying wireless technologies.

The MHD 110 includes a processor 111, a memory 112 that is communicatively connected to the processor 111, and an input-output element 119 that is communicatively connected to the processor 111. The memory 112 includes a buffer 113 and a communication protocol stack 114, both of which are configured to support communications by the MHD 110. The buffer 113 is configured to store, in various forms as may be provided or supported at various communication layers of communication protocol stack 114, data intended for upstream transmission from the MHD 110 toward the WAD 120 and data received via downstream transmission from the WAD 120 to the MHD 110.

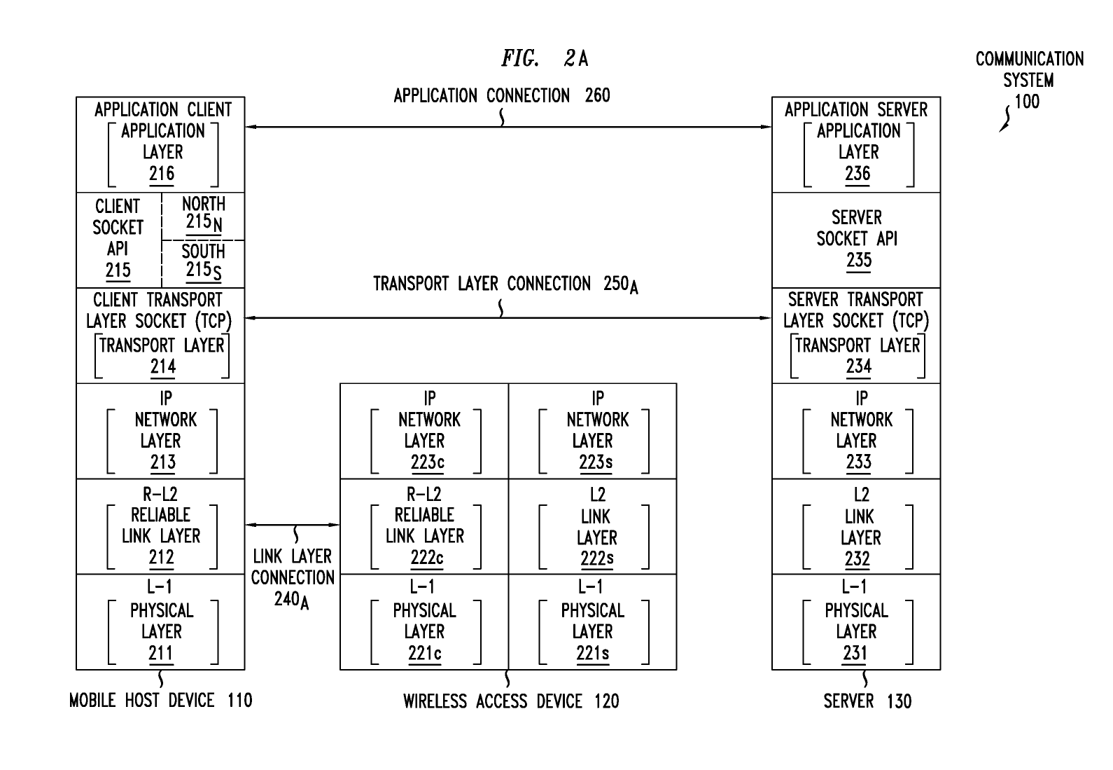

As presented further with respect to FIG. 2A and FIG. 2B, for a transport layer connection of the MHD 110, the communication protocol stack 114 of the MHD 110 may or may not include the client transport layer socket for the transport layer connection of the MHD 110 as the client transport layer socket for the transport layer connection of the MHD 110 may be provided locally on the MHD 110 (as presented with respect to FIG. 2A) or may be networked on the WAD 120 (as presented with respect to FIG. 2B). The MHD 110 is configured to support communications for a transport layer connection of the MHD 110 when the client transport layer socket for the transport layer connection of the MHD 110 is provided locally on the MHD 110 and when the client transport layer socket for the transport layer connection of the MHD 110 is provided on the WAD 120. For example, the MHD 110 may be a smartphone, a tablet computer, a laptop computer, or the like. It will be appreciated that, although omitted from FIG. 1 for purposes of clarity, MHD 110 may include various other devices, elements, or the like, as well as various combinations thereof.

The wireless access device 120 includes a processor 121, a memory 122 that is communicatively connected to the processor 121, and an input-output element 129 that is communicatively connected to the processor 121. The memory 122 includes a buffer 123 and a communication protocol stack 124, both of which are configured to support communications by the WAD 120. The buffer 123 is configured to store, in various forms as may be provided or supported at various communication layers of communication protocol stack 124, both data communicated or intended for communication between the MHD 110 and the WAD 120 and data communicated or intended for communication between the WAD 120 and the server 130.

As presented further with respect to FIG. 2A and FIG. 2B, for a transport layer connection of the MHD 110, the communication protocol stack 124 of the WAD 120 may or may not include the client transport layer socket for the transport layer connection of the MHD 110, as the client transport layer socket for the transport layer connection of the MHD 110 may be provided on the MHD 110 (as presented with respect to FIG. 2A) or may be networked on the WAD 120 (as presented with respect to FIG. 2B). The WAD 120 is configured to support communications for a transport layer connection of the MHD 110 when the client transport layer socket for the transport layer connection of the MHD 110 is provided on the MHD 110 and when the client transport layer socket for the transport layer connection of the MHD 110 is provided on the WAD 120. For example, the wireless access device 110 may be a cellular access point (e.g., a NodeB, an eNodeB, a femtocell, a picocell, or the like), a WiFi access point, or the like. It will be appreciated that, although omitted from FIG. 1 for purposes of clarity, WAD 120 may include various other devices, elements, or the like, as well as various combinations thereof.

The server 130 includes a processor 131, a memory 132 that is communicatively connected to the processor 131, and an input-output element 139 that is communicatively connected to the processor 131. The memory 132 includes a buffer 133 and a communication protocol stack 134, both of which are configured to support communications by the server 130. The buffer 133 is configured to store, in various forms as may be provided or supported at various communication layers of communication protocol stack 134, data communicated or intended for communication between server 130 and WAD 120.

As presented further with respect to FIG. 2A and FIG. 2B, communication protocol stack 134 of the server 130 is configured to support communications for WAD 120 (e.g., communications of MHD 110 that are received from WAD 120 via a transport layer connection of MHD 110 and communications intended for MHD 110 that are provided to WAD 120 via a transport layer connection of MHD 110). For example, the server 130 may be an application server, a video server, a communications server, or the like. It will be appreciated that, although omitted from FIG. 1 for purposes of clarity, server 130 may include various other devices, elements, or the like, as well as various combinations thereof.

The wireless communication link 140 between the MHD 110 and the WAD 120 may be provided using any suitable type of wireless technology by which the MHD 110 may access the WAD 120 wirelessly. For example, the wireless communication link 140 may be based on LTE, WiFi, a 5G link technology, or the like.

The network communication path 150 between the WAD 120 and the server 130 may be provided using any suitable communication network(s) and associated communication network technologies. For example, the network communication path 150 may include a wireless access network, a wireless core network, the Internet, or the like, as well as various combinations thereof.

It will be appreciated that, although primarily presented with respect to embodiments in which the MHD 110, the WAD 120, and the server 130 are configured in a particular manner and interact in a particular manner, the MHD 110, the WAD 120, or the server 130 may be configured in other ways, may interact in other ways, or the like, as well as various combinations thereof.

FIGS. 2A and 2B depict the communication protocol stacks of the mobile host device, the wireless access device, and the server of the communication system of FIG. 1 for illustrating different placements of the client transport layer socket for a transport layer connection of the mobile host device.

As depicted in FIGS. 2A and 2B, the communication system 100, as previously discussed, includes the MHD 110, the WAD 120, and the server 130.

As depicted in FIGS. 2A and 2B, the communication protocol stack 114 of MHD 110 includes a physical layer 211 (denoted as L1), a reliable link layer 212 (denoted as R-L2), a client socket API 215 (which may include a client socket API—north 215_{N} and a client socket API—south 215_{S} which, together, may provide the client socket API 215), and an application layer 216 (supporting an Application Client). The communication protocol stack 114 of MHD 110 may include a transport layer when the client transport layer socket for a transport layer connection of the MHD 110 is provided locally on the MHD 110 (as presented with respect to FIG. 2A) or may not include a transport layer when the client transport layer socket for a transport layer connection of the MHD 110 is networked by providing the transport layer socket for the transport layer connection of the MHD 110 on the WAD 120 (as presented with respect to FIG. 2B). In both cases, the transport layer and associated transport layer socket are denoted using TCP as it is assumed that the transport layer is based on TCP (although it will be appreciated that other transport layer protocols, such as UDP or the like, may be used). In general, the client socket API 215 is an application programming interface that is configured to allow application programs to control and use network sockets.

As depicted in FIGS. 2A and 2B, the communication protocol stack 124 of WAD 120 has a client-facing portion (elements of which are denoted using a subscript “C”) and a server-facing portion (elements of which are denoted using a subscript “S”). The communication protocol stack 124 of WAD 120 may not include a client socket API when the client transport layer socket for a transport layer connection of the MHD 110 is provided locally on the MHD 110 (as presented with respect to FIG. 2A) or may include a client socket API when the client transport layer socket for a transport layer connection of the MHD 110 is networked by providing the transport layer socket for the transport layer connection of the MHD 110 on the WAD 120 (as presented with respect to FIG. 2B). As depicted in FIGS. 2A and 2B, the client-facing portion of the communication protocol stack 124 includes a physical layer 221_{C} (denoted as L1) and a reliable link layer 222_{C} (denoted as R-L2). The client-facing portion of the communication protocol stack 124 may include a network layer 223_{C} when the client transport layer socket for a transport layer connection of the MHD 110 is provided locally on the MHD 110 (as presented with respect to FIG. 2A) or may not include a network layer when the client transport layer socket for a transport layer connection of the MHD 110 is networked by providing the transport layer socket for the transport layer connection of the MHD 110 on the WAD 120 (as presented with respect to FIG. 2B).

As depicted in FIGS. 2A and 2B, the server-facing portion of the communication protocol stack 124 includes a physical layer 221_{S} (denoted as L1), a link layer 222_{S} (denoted as L2), and a network layer 223_{S} (denoted as IP). The server-facing portion of the communication protocol stack 124 may not include a transport layer when the client transport layer socket for a transport layer connection of the MHD 110 is provided locally on the MHD 110 (as presented with respect to FIG. 2A) or may include a transport layer (denoted as TCP as it is assumed that the transport layer is based on TCP) when the client transport layer socket for a transport layer connection of the MHD 110 is networked by providing the transport layer socket for the transport layer connection of the MHD 110 on the WAD 120 (as presented with respect to FIG. 2B).

As depicted in FIGS. 2A and 2B, the communication protocol stack 134 of the server 130 includes a physical layer 231 (denoted as L1), a link layer 232 (denoted as L2), a network layer 233 (denoted as IP), a transport layer 234 (which provides a server transport layer socket, and which is denoted as TCP since it is assumed that the transport layer is based on TCP), a server socket API 235, and an application layer 236 (supporting an Application Server).

As depicted in FIGS. 2A and 2B, the client socket API 215 running on the MHD 110 may be configured to discover whether the WAD 120 to which the MHD 110 is attaching or is attached is configured to support a networked client transport layer socket for the MHD 110 and, further, to control the placement of the client transport layer socket for the MHD 110 based on whether the WAD 120 to which the MHD 110 is attaching or attached is configured to support a networked client transport layer socket for the MHD 110.

As depicted in FIGS. 2A and 2B, the client socket API 215 running on the MHD 110 may be configured to discover whether the WAD 120 to which the MHD 110 is attaching or is attached is configured to support a networked client transport layer socket for the MHD 110. The client socket API 215 running on the MHD 110 may be configured to discover whether the WAD 120 is configured to support a networked client transport layer socket for the MHD 110 during network attachment of the MHD 110 to the WAD 120 (e.g., during network attachment of the MHD 110 to the WAD 120, the network may provide capability information for the WAD 120 that is indicative as to whether WAD 120 is configured to support a networked client transport layer socket for the MHD 110). The client socket API 215 running on the MHD 110 may be configured to discover whether the WAD 120 is configured to support a networked client transport layer socket for the MHD 110 after network attachment of the MHD 110 to the WAD 120 and establishment of the link layer connection 240_{A} between the MHD 110 and the WAD 120 (e.g., the client socket API 215 running on MHD 110 may start an exchange of information with the WAD 120 to request and obtain capability information for the WAD 120 that is indicative as to whether WAD 120 is configured to support a networked client transport layer socket for the MHD 110).

As depicted in FIGS. 2A and 2B, the client socket API 215 running on the MHD 110 may be configured to control the placement of the client transport layer socket for the MHD 110 based on whether the WAD 120 to which the MHD 110 is attaching or attached is configured to support a networked client transport layer socket for the MHD 110. The client socket API 215 running on the MHD 110, based on a determination that the WAD 120 is not configured to support a networked client transport layer socket for the MHD 110, initiates opening of the client transport layer socket for the MHD 110 on the MHD 110 (as may be further understood by way of reference to FIG. 2A). The client socket API 215 running on the MHD 110, based on a determination that the WAD 120 is configured to support a networked client transport layer socket for the MHD 110, initiates opening of the client transport layer socket for the MHD 110 on the WAD 120 (as may be further understood by way of reference to FIG. 2B).

FIG. 2A depicts the communication protocol stacks of the mobile host device, the wireless access device, and the server of the communication system of FIG. 1 when the client transport layer socket of the mobile host device is provided on the mobile host device.

As depicted in FIG. 2A, the client socket API 215 running on the MHD 110, based on a determination that the WAD 120 is not configured to support a networked client transport layer socket for the MHD 110, initiates opening of the client transport layer socket for the MHD 110 on the MHD 110. The opening of the client transport layer socket for the MHD 110 on the MHD 110 provides a transport layer for the MHD 110 locally on the MHD 110. This is illustrated in FIG. 2A as transport layer 214 (which also may be referred to as the client transport layer socket) on the MHD 110. The client transport layer socket (transport layer 214) for the MHD 110 is opened on the MHD 110 between the client socket API 215 and the network layer 213. In this case, the functionality of the client socket API 215 (including the client socket API—north 215_{N} and the client socket API—south 215_{S} which, together, may provide the client socket API 215) is provided on the MHD 110. As a result, the transport layer connection for the MHD 110 runs end-to-end between the client transport layer socket (transport layer 214) on the MHD 110 and the transport layer 234 on the server 130 (this is depicted as transport layer connection 250_{A}). The transport layer connection 250_{A} is supported by a link layer connection 240_{A} between the reliable link layer 212 of MHD 110 and the reliable link layer 222_{C} of WAD 120. The transport layer connection 250_{A} supports the application connection 260 between the application client of the application layer 216 of MHD and the application server of the application layer 236 of server 130. In this case, the communication of application data between the application client of the application layer 216 of MHD and the application server of the application layer 236 of server 130 via the application connection 260 proceeds as it normally would in the absence of networking of the client transport layer socket for the MHD 110 on the WAD 120 (which embodiment is further presented with respect to FIG. 2B).

FIG. 2B depicts the communication protocol stacks of the mobile host device, the wireless access device, and the server of the communication system of FIG. 1 when the client transport layer socket of the mobile host device is networked on the wireless access device.

As depicted in FIG. 2B, the client socket API 215 running on the MHD 110, based on a determination that the WAD 120 is configured to support a networked client transport layer socket for the MHD 110, initiates opening of the client transport layer socket for the MHD 110 on the WAD 120. The opening of the client transport layer socket for the MHD 110 on the WAD 120 provides a transport layer 224_{S} for the MHD 110 on the WAD 120. This is illustrated in FIG. 2B as transport layer 224_{S} (which also may be referred to as the client transport layer socket) on the WAD 120. The opening of the client transport layer socket for the MHD 110 on the WAD 120 causes the client transport layer socket to be considered to be networked (as it is hosted in the network on the WAD 120, rather than being provided locally on the MHD 110) and, thus, the client transport layer socket also may be referred to as the networked client transport layer socket. The opening of the networked client transport layer socket (transport layer 224_{S}) for the MHD 110 on the WAD 120 causes the client socket API 215 to be split between the MHD 110 (with the client socket API—north 215_{N} endpoint of the client socket API 215 being provided on the MHD 110 and the client socket API—south 215_{S} endpoint of the client socket API 215 being provided on the WAD 120). The networked client transport layer socket (transport layer 224_{S}) for the MHD 110 is opened on the WAD 120, on the server-facing portion of the communication protocol stack 124, between the client socket API—south 215_{S} endpoint of the client socket API 215 being provided on the WAD 120 and the network layer 223_{S} of the WAD 120. The client socket API—south 215_{S} endpoint of the client socket API 215 is provided on the WAD 120 above the reliable link layer 222_{C} on the client-facing portion of the communication protocol stack 124 of the WAD 120 and the networked client transport layer socket (transport layer 224_{S}) on the server-facing portion of the communication protocol stack 124 of the WAD 120. As a result, a client socket API connection 245 runs between the client socket API—north 215_{N} endpoint of the client socket API 215 on the MHD 110 and the client socket API—south 215_{S} endpoint of the client socket API 215 on the WAD 120 and the transport layer connection for the MHD 110 runs between the networked client transport layer socket (transport layer 224_{S}) on the server-facing portion of the communication protocol stack 124 of the WAD 120 and the transport layer 234 on the server 130 (this is depicted as transport layer connection 250_{B}). The client socket API connection 245 is supported by a link layer connection 240_{B} between the reliable link layer 212 of MHD 110 and the reliable link layer 222_{C} of WAD 120. The client socket API connection 245 and the transport layer connection 250_{B} support the application connection 260 between the application client of the application layer 216 of MHD 110 and the application server of the application layer 236 of server 130. In this case, the communication of application data between the application client of the application layer 216 of MHD 110 and the application server of the application layer 236 of server 130 via the application connection 260 is based on communication of the application data via the client socket API connection 245 based on the client socket API functionality provided on the MHD 110 (namely, the client socket API—north 215_{N} endpoint of the client socket API 215) and based on the client socket API functionality provided on the WAD 120 (namely, the client socket API—south 215_{S} endpoint of the client socket API 215).

As depicted in FIG. 2B, the client socket API 215, when the client transport layer socket is provided on the WAD 120 (illustratively, as the networked client transport layer socket (transport layer 224_{S})), is provided using a combination of the client socket API—north 215_{N} endpoint on the MHD 110 and the client socket API—south 215_{S} endpoint on the WAD 120 and, thus, the client socket API—north 215_{N} endpoint on the MHD 110 may be configured to provide various socket API functions and, similarly, the client socket API—south 215_{S} endpoint on the WAD 120 may be configured to provide various socket API functions. In this case, the client socket API 215 (again, both client socket API—north 215_{N} and client socket API—south 215_{S}), as discussed further below, is configured to support a set of communication primitives configured to support communication between the application layer 216 of the MHD 110 and the networked client transport layer socket (transport layer 224_{S}) that is hosted by the WAD 120 on behalf of the MHD 110.

In FIG. 2B, the client socket API 215 is configured to support communication of data between the application layer 216 of MHD 110 and the networked client transport layer socket (transport layer 224_{S}) that is hosted by the WAD 120 via the link layer connection 240_{B} between the reliable link layer 212 of MHD 110 and the reliable link layer 222_{C} of WAD 120.

The link layer connection 240_{B} is a reliable link layer connection that is configured to support reliable delivery of data between MHD 110 and WAD 120, as lack of a transport layer connection between MHD 110 and WAD 120 (rather, as depicted in FIG. 2B, the transport layer connection 250B is between the networked client transport layer socket (transport layer 224_{S}) on the network-facing portion of the communication protocol stack 124 of the WAD 120 and the transport layer 234 on the server 130) means that reliability features of the transport layer are not available for this purpose. The configuration of the link layer connection 240_{B} (and, thus, the operation of the reliable link layer 212 of MHD 110 and the reliable link layer 222_{C} of WAD 120) may vary for different types of link layers, such as cellular, WiFi, or the like.

For example, where the link layer connection 240_{B} is provided using LTE, the link layer connection 240_{B} is called a radio bearer or simply a bearer and the reliable link layer (namely, the reliable link layer 212 of MHD 110 and the reliable link layer 222_{C} of WAD 120) may be divided into three sub-layers which are referred to as the Medium Access Control (MAC) sub-layer, the Radio Link Control (RLC) sub-layer, and the Packet Data Convergence Protocol (PDCP) sub-layer. The PDCP sub-layer is the highest of the sub-layers (i.e., closest to the application layer/farthest from the physical layer), the MAC sub-layer is the lowest of the sub-layers (i.e., closest to the physical layer/farthest from the application layer), and the RLC sub-layer is disposed therebetween. It will be appreciated that each radio bearer may elect to operate the RLC sublayer in one of three different modes: the transparent mode (TM), the unacknowledged mode (UM), or the acknowledged mode (AM). In the acknowledged mode, which is typically the mode of RLC operation for the default radio bearer, which in turn is typically the default choice for carrying the best-effort traffic that normally relies on TCP for end-to-end transport, the RLC endpoints implement a mechanism for protected data transmission whose end result is the in-order delivery of data units to the receiving end of the PDCP sublayer. As such, use of the acknowledged mode between the reliable link layer 212 of MHD 110 and the reliable link layer 222_{C} of WAD 120 provides reliable delivery of data between the MHD 110 and the WAD 120.

For example, where the link layer connection 240_{B} is provided using WiFi, the reliable link layer (namely, reliable link layer 212 of MHD 110 and reliable link layer 222_{C} of WAD 120) may be configured to support communication of data using 802.11 unicast frames. It is noted that, in WiFi networks, the 802.11 standard mandates the transmission of a link-layer acknowledgement for each unicast data frame received by a station and the transmitting station must wait for the acknowledgment frame before it can transmit a new unicast data frame. As such, use of WiFi to provide the link layer connection 240_{B} of MHD 110 and the reliable link layer 222_{C} of WAD 120 provides reliable delivery of data between the MHD 110 and the WAD 120.

It will be appreciated that other types of reliable data link technologies may be used to provide the link layer connection 240_{B} and, thus, to support reliable delivery of data between MHD 110 and WAD 120.

The link layer connection 240_{B} may be provided over a physical layer connection which may be provided between the physical layer 211 of the MHD 110 and the physical layer 221_{C} of WAD 120. This is depicted in FIG. 1 as being a wireless connection using resources of a wireless communication medium. The wireless communication link 140 is configured to support transport of data of the link layer connection 240_{B} between the MHD 110 and the WAD 120. The wireless communication link 140 may be considered to include the physical layer connection between the physical layer 211 of the MHD 110 and the physical layer 221 of the WAD 120 and the link layer connection 240_{B} between the reliable link layer 212 of the MHD 110 and the reliable link layer 222_{C} of the WAD 120.

In FIG. 2B, the client socket API 215 is configured such that data of the application layer 216 of the MHD 110 (e.g., sourced by the application layer 216 or intended for delivery to the application layer 216), rather than being passed between the application layer 216 of the MHD 110 and a transport layer of the MHD 110 internally within the MHD 110 (as would be the case if the transport layer of the MHD 110 was provided within the MHD 110 as in FIG. 2A), is passed between the application layer 216 of the MHD 110 and the networked client transport layer socket (transport layer 224_{S}) which is hosted within the WAD 120 on behalf of the MHD 110) via the link layer connection 240_{B} that is running over a physical connection between the MHD 110 and the WAD 120 (e.g., wireless communication link 140).

In FIG. 2B, as noted above, the client socket API 215 is configured to support a set of communication primitives configured to support communication between the application layer 216 of the MHD 110 and the networked client transport layer socket (transport layer 224_{S}) that is hosted on the WAD 120 on behalf of the MHD 110. The communication primitives of the client socket API 215 may include primitive rules for controlling manipulation of data (e.g., encapsulation and decapsulation of application data that is sourced by the application layer 216 for transmission toward the server 130, encapsulation and decapsulation of application data that is sourced by server 130 and that is intended for delivery to the application layer 216 of the MHD 110, or the like), primitive messages and associated primitive message formats that are configured to transport data of the application layer 216, or the like, as well as various combinations thereof.

In FIG. 2B, in a direction of transmission from the application layer 216 of the MHD 110 toward the application layer 236 of the server 130, communication of the application data of the application layer 216 of MHD 110 may be performed as follows. The client socket API—north 215_{N} running on MHD 110 places the application data into primitive messages supported by the client socket API 215 and passes the primitive messages including the application data to the reliable link layer 212 of the MHD 110. The reliable link layer 212 of the MHD 110 receives the primitive messages, places the primitive messages into link layer data structures supported by the reliable link layer 212 (which, as previously discussed, may vary for different types of link layers, such as cellular, WiFi, or the like), and passes the link layer data structures including the primitive messages to the physical layer 211 of the MHD 110. For example, where the reliable link layer 212 of MHD 110 is provided using LTE, the reliable link layer 212 may place the primitive messages into PDCP protocol data units (PDUs), place the PDCP PDUs into RLC AM service data units (SDUs), place the RLC AM SDUs into RLC AM PDUs, place the RLC AM PDUs into MAC SDUs, place the MAC SDUs into MAC PDUs, and provide the MAC PDUs to the physical layer 211. For example, where the reliable link layer 212 is provided using WiFi, the reliable link layer 212 of MHD 110 may place the primitive messages into 802.11 unicast frames and provide the 802.11 unicast frames to the physical layer 211. The physical layer 211 of the MHD 110 receives the link layer data structures from the reliable link layer 212 of the MHD 110 and transmits the link layer data structures from the MHD 110 toward WAD 120 wirelessly via the wireless communication link 140. The physical layer 221 of the WAD 120 receives the link layer data structures of the reliable link layer 212 of the MHD 110 wirelessly via the wireless communication link 140. The physical layer 221 of the WAD 120 provides the link layer data structures of the reliable link layer 212 of the MHD 110 to the reliable link layer 222_{C} of the WAD 120. The reliable link layer 222_{C} of the WAD 120 receives the link layer data structures of the reliable link layer 212 of the MHD 110 from the physical layer 221 of the WAD 120, processes the link layer data structures of the reliable link layer 212 of the MHD 110 to recover the primitive messages included therein (which, as previously discussed, may vary for different types of link layers, such as cellular, WiFi, or the like), and provides the primitive messages to the client socket API—south 215_{S} running on the WAD 120. For example, where the reliable link layer 222_{C} of WAD 120 is provided using LTE, the reliable link layer 222_{C} may extract the MAC SDUs from the MAC PDUs, extract the RLC AM PDUs from the MAC SDUs, extract the RLC AM SDUs from the RLC AM PDUs, extract the PDCP PDUs from the RLC AM SDUs, extract the primitive messages from the PDCP PDUs, and provide the primitive messages to the south client socket API 225 running on the WAD 120. For example, where the reliable link layer 222_{C} of WAD 120 is provided using WiFi, the reliable link layer 222_{C} may extract the primitive messages from the 802.11 unicast frames and provide the primitive messages to the client socket API—south 215_{S} running on the WAD 120. The client socket API—south 215_{S} running on WAD 120 receives the primitive messages from the reliable link layer 222_{C} of WAD 120, extracts the application data of the application layer 216 of MHD 110 from the primitive messages supported by the client socket API 215, and provides the application data of the application layer 216 of MHD 110 to the networked client transport layer socket (transport layer 224_{S}) of the WAD 120 for transport to the server 130 via the transport layer connection 250_{B} between the WAD 120 and the server 130 (illustratively, a TCP connection).

In FIG. 2B, in a direction of transmission from the application layer 236 of the server 130 toward the application layer 216 of the MHD 110, communication of the application data of the application layer 236 of the server 230 may be performed as follows. The server 130 transmits the application data to the WAD 120 via the transport layer connection 250_{B} between the WAD 120 and the server 130 (illustratively, a TCP connection). The client socket API—south 215_{S} running on WAD 120 receives the application data from the networked client transport layer socket (transport layer 224_{S}) on the WAD 120. The client socket API—south 215_{S} running on WAD 120 places the application data into primitive messages supported by the client socket API 215 and passes the primitive messages including the application data to the reliable link layer 222_{C} of the WAD 120. The reliable link layer 222_{C} of the WAD 120 receives the primitive messages, places the primitive messages into link layer data structures supported by the reliable link layer 222_{C} (which, as previously discussed, may vary for different types of link layers, such as cellular, WiFi, or the like), and passes the link layer data structures including the primitive messages to the physical layer 221 of the WAD 120. For example, where the reliable link layer 222_{C} of the WAD 120 is provided using LTE, the reliable link layer 222_{C} may place the primitive messages into PDCP PDUs, place the PDCP PDUs into RLC AM SDUs, place the RLC AM SDUs into RLC AM PDUs, place the RLC AM PDUs into MAC SDUs, place MAC SDUs into MAC PDUs, and provide the MAC PDUs to the physical layer 221. For example, where the reliable link layer 222_{C} of the WAD 120 is provided using WiFi, the reliable link layer 222_{C} may place the primitive messages into 802.11 unicast frames and provide the 802.11 unicast frames to the physical layer 221. The physical layer 221 of the WAD 120 receives the link layer data structures from the reliable link layer 222_{C} of the WAD 120 and transmits the link layer data structures from the WAD 120 toward MHD 110 wirelessly via the wireless communication link 140. The physical layer 211 of the MHD 110 receives the link layer data structures of the reliable link layer 222_{C} of the WAD 120 wirelessly via the wireless communication link 140. The physical layer 211 of the MHD 110 provides the link layer data structures of the reliable link layer 222_{C} of the WAD 120 to the reliable link layer 212 of the MHD 110. The reliable link layer 212 of the MHD 110 receives the link layer data structures of the reliable link layer 222_{C} of the WAD 120 from the physical layer 211 of the MHD 110, processes the link layer data structures of the reliable link layer 222_{C} of the WAD 120 to recover the primitive messages included therein (which, as previously discussed, may vary for different types of link layers, such as cellular, WiFi, or the like), and provides the primitive messages to the client socket API—north 215_{N} of the MHD 110. For example, where the reliable link layer 212 of MHD 110 is provided using LTE, the reliable link layer 212 may extract the MAC SDUs from the MAC PDUs, extract the RLC AM PDUs from the MAC SDUs, extract the RLC AM SDUs from the RLC AM PDUs, extract the PDCP PDUs from the RLC AM SDUs, extract the primitive messages from the PDCP PDUs, and provide the primitive messages to the client socket API—north 215_{N} of the MHD 110. For example, where the reliable link layer 212 of MHD 110 is provided using WiFi, the reliable link layer 212 may extract the primitive messages from the 802.11 unicast frames and provide the primitive messages to the client socket API—north 215_{N} of the MHD 110. The client socket API—north 215_{N} running on MHD 110 receives the primitive messages from the reliable link layer 212 of MHD 110, extracts the application data of the application layer 236 of server 130 from the primitive messages supported by the client socket API 215, and provides the application data of the application layer 236 of server 130 to the application layer 216 of the MHD 110.

In FIG. 2B, the client socket API 215 may be configured to control data transmissions of MHD 110 based on use of a networked client transport layer socket for the MHD 110. The client socket API 215 may be configured to control data transmissions of the application layer 216 of MHD 110 based on use of a networked client transport layer socket for the MHD 110. The client socket API 215 may be configured such that, when a primitive message of the client socket API 215 is transmitted (e.g., in an upstream direction from the client socket API—north 215_{N} running on MHD 110 toward the client socket API—south 215_{S} running on WAD 120 or in a downstream direction from the client socket API—south 215_{S} running on WAD 120 toward the client socket API—north 215_{N} running on the MHD 110), the primitive message of the client socket API 215 is maintained locally in a link layer buffer of the device from which the primitive message of the client socket API 215 is transmitted (which may vary for different types of link layers, such as cellular, WiFi, or the like) until receipt of the primitive message is acknowledged by the other side of the link layer connection 240_{B} between MHD 110 and WAD 120. For example, where the reliable link layer is provided using LTE, the primitive message may be maintained in a PDCP sub-layer buffer associated with the PDCP sub-layer of the reliable link layer. For example, where the reliable link layer is provided using WiFi, the primitive message may be maintained in a link-layer buffer associated with the reliable link layer (e.g., which may typically, but is not required to, reside in the device driver). The use of acknowledgments at the data link layer provides reliability for transmission of data between the MHD 110 and the WAD 120 without relying on transport layer reliability mechanisms.

In FIG. 2B, the client socket API 215, when the transport layer socket of the MHD 110 is networked on the WAD 120, may recognize that a given primitive message sent by the client socket API 215 has been successfully delivered via the wireless communication link 140 when the given primitive message is removed from a link layer buffer of the device from which the primitive message was sent.

In the upstream direction, for example, the client socket API—north 215_{N} running on the MHD 110, when the transport layer socket of the MHD 110 is networked on the WAD 120 as networked client transport layer socket (transport layer 224_{S}), may recognize that a given primitive message sent by the client socket API—north 215_{N} running on the MHD 110 has been successfully delivered to the client socket API—south 215_{S} running on the WAD 120 when the given primitive message is removed from a link layer buffer of MHD 110. The application layer 216 of the MHD 110 can monitor the state of the link layer buffer (e.g., PDCP sub-layer buffer, WiFi link-layer buffer, or the like) and control its rate of data generation based on monitoring of the state of the link layer buffer. The application layer 216 of the MHD 110 may be configured to control its rate of data generation, based on the monitoring of the state of the link layer buffer, in a manner configured to ensure that the link layer buffer is never empty and, therefore, that the application layer 216 achieves full utilization of the available link bandwidth. The application layer 216 may be configured to control its rate of data generation, based on the monitoring of the state of the link layer buffer, in a manner configured to prevent accumulation of a large number of packets in the link layer buffer and, thus, ensuring tight responsiveness that may be used to provide guaranteed interactivity.

In the downstream direction, for example, the client socket API—south 215_{S} running on the WAD 120, when the transport layer socket of the MHD 110 is networked on the WAD 120 as networked client transport layer socket (transport layer 224_{S}), may recognize that a given primitive message sent by the client socket API—south 215_{S} running on the WAD 120 has been successfully delivered to the client socket API—north 215_{N} running on the MHD 110 when the given primitive message is removed from a link layer buffer of the WAD 120. In the downstream direction, the networked client transport layer socket (transport layer 224_{S}) may apply similar principles (similar to those discussed above as being used by the application layer 216 of MHD 110 to control data transmission) in order to increase or maximize throughput, decrease or minimize end-end-end delay between the server 130 and the MHD 110, or the like, as well as various combinations thereof.

It is noted that use of a networked client transport layer socket by the MHD 110 may preserve the reliability of the end-to-end data transfer between the MHD 110 and the server 130 during a mobility event (e.g., a handover or other type of mobility event) associated with the MHD 110. For example, consider a mobility event in which a handover of the MHD 110 causes the MHD 110 to switch from being attached to the WAD 120 to being attached to a new WAD. With use of the networked client transport layer socket, the link layer buffer at the WAD 120 (e.g., the PDCP sub-layer buffer in the case of LTE, the link-layer buffer in the case of WiFi, or the like) is essentially the buffer of the transport layer receiver such that, when the handover from WAD 120 to the new WAD takes place, packets that are currently buffered in the link layer buffer of the WAD 120 are transferred to the new WAD using standard handover methods without additional overhead. If the new WAD supports networked client transport layer sockets, then a new client transport layer socket is opened for the MHD 110 on the new WAD so as to provide a new networked client transport layer socket for the MHD 110. If the new WAD does not support networked client transport layer sockets, then a new client transport layer socket is opened for the MHD 110 locally on the MHD 110 (namely, between the client socket API 215 and the network layer 213 of the communication protocol stack 114 of the MHD 110 as depicted in FIG. 2A).

It will be appreciated that, although primarily presented with respect to embodiments in which the WAD 120 includes only a single communication protocol stack, the WAD 120 may include multiple communication protocol stacks (e.g., one for each network interface supported by the WAD 120). In at least some such embodiments, when each of the multiple interfaces includes a separate IP address, the multiple stacks may start at the IP layer. It will be appreciated that other implementations of WAD 120 may be used.

It will be appreciated that the MHD 110 and the WAD 120 may be configured to provide various other functions for supporting embodiments of the networked transport layer socket capability. It will be appreciated that the MHD 110 and the WAD 120 may be configured to use client socket API 215 to provide various other functions for supporting embodiments of the networked transport layer socket capability and, similarly, that the client socket API 215 may be configured to provide various other functions for supporting embodiments of the networked transport layer socket capability.

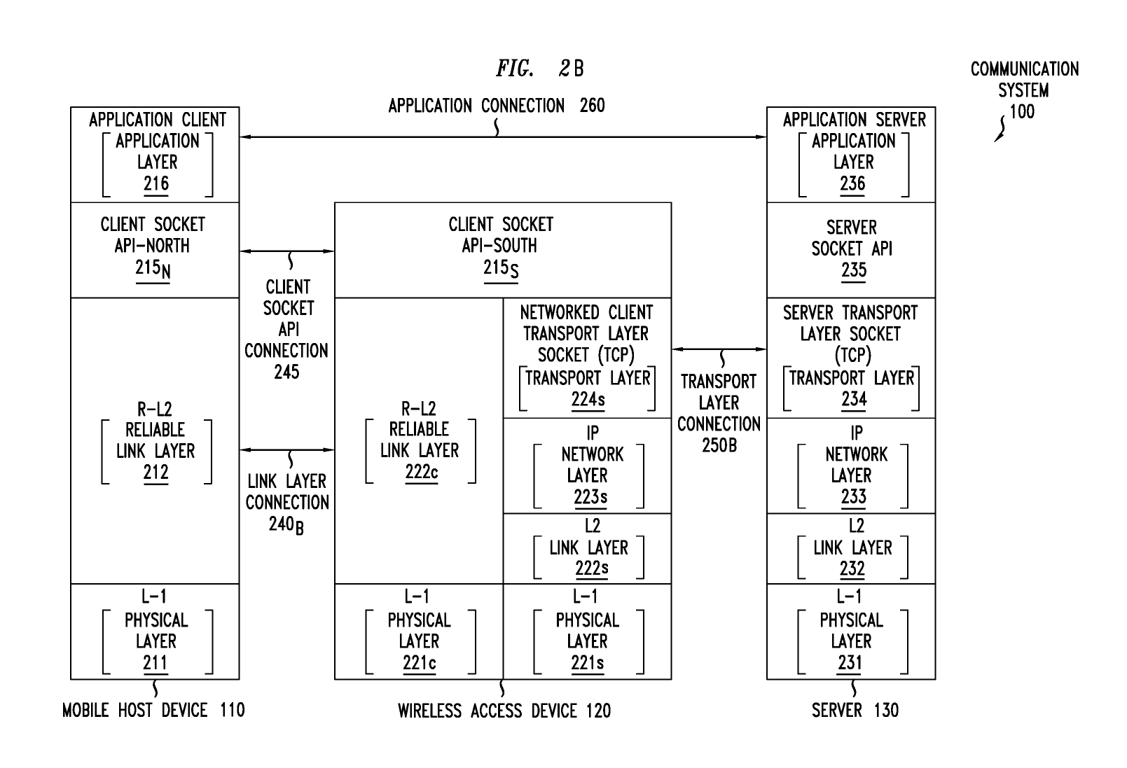

FIG. 3 depicts an embodiment of a method for use by the mobile host device of the communication system of FIG. 1. It will be appreciated that, although primarily presented as being performed serially in FIG. 3, at least a portion of the functions of method 300 of FIG. 3 may be performed contemporaneously or in a different order than as presented in FIG. 3. At block 301, method 300 begins. At block 310, the mobile host device runs a communication protocol stack including an application layer, a client socket API, a link layer (e.g., a reliable link layer), and a physical layer. At block 320, the client socket API of the mobile host device communicates data, between the application layer and the networked client transport layer socket hosted on the wireless access device for the mobile host device, via the link layer and the physical layer. The client socket API of the mobile host device communicates data, between the application layer and a networked client transport layer socket hosted on a wireless access device for the mobile host device, based on interaction with the link layer (e.g., providing data for the link layer for communications sourced by the application layer of the mobile host device and receiving data provided by the link layer for communications intended for delivery to the application layer of the mobile host device). The client socket API of the mobile host device provides an interface between the application layer and the link layer, at the mobile host device, that does not traverse a transport layer at the mobile host device. At block 399, method 300 ends.

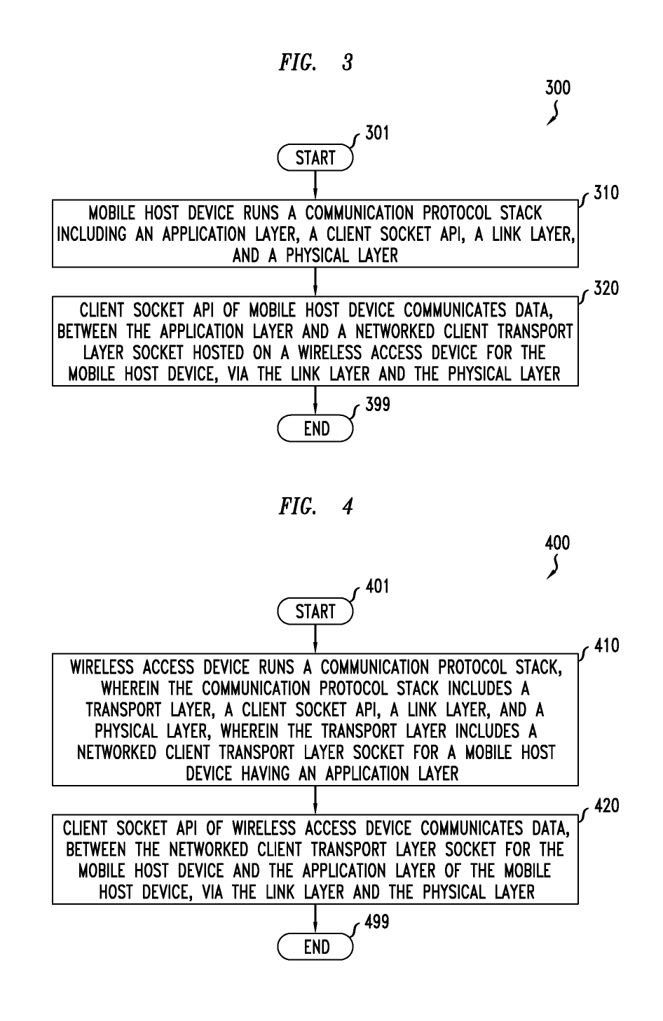

FIG. 4 depicts an embodiment of a method for use by the wireless access device of the communication system of FIG. 1. It will be appreciated that, although primarily presented as being performed serially in FIG. 4, at least a portion of the functions of method 400 of FIG. 4 may be performed contemporaneously or in a different order than as presented in FIG. 4. At block 401, method 400 begins. At block 410, the wireless access device runs a communication protocol stack. The communication protocol stack includes a transport layer, a client socket API, a link layer (e.g., a reliable link layer), and a physical layer. The transport layer provides a networked client transport layer socket for a mobile host device having an application layer. At block 420, the client socket API of the wireless access device communicates data, between the networked client transport layer socket for the mobile host device and the application layer of the mobile host device, via the link layer and the physical layer. The client socket API of the wireless access device communicates data, between the networked client transport layer socket for the mobile host device and the application layer of the mobile host device, based on interaction with the link layer (e.g., receiving data provided by the link layer for communications sourced by the application layer of the mobile host device and providing data for the link layer for communications intended for delivery to the application layer of the mobile host device). The client socket API of the wireless access device provides an interface between the networked client transport layer socket of the server-facing transport layer and the link layer at the wireless access device (rather than between an application layer and a transport layer). At block 499, method 400 ends.

Various embodiments of the networked transport layer socket capability may be configured to provide various advantages or potential advantages.

For example, various embodiments of the networked transport layer socket capability may be configured to eliminate the need for the transport protocol to send acknowledgment packets over the wireless communication link and, thus, may reduce or eliminate the negative impact that the transmission of acknowledgment packets over the wireless communication link has on the utilization of the wireless communication link and on the performance of network applications that rely on TCP for end-to-end transport over the wireless communication link.

For example, various embodiments of the networked transport layer socket capability may be configured to reduce or eliminate the negative impact of the wireless communication link on the ability of a TCP sender to keep the size of its congestion window tightly aligned with the current conditions of the end-to-end path.

For example, various embodiments of the networked transport layer socket capability may be configured to simplify the handling of mobility events as compared to other solutions for optimizing TCP performance over wireless communication links.

For example, various embodiments of the networked transport layer socket capability may provide improvements in computer performance in supporting communications between devices of communication networks such as communication network 100. For example, various embodiments of the networked transport layer socket capability may provide improvements in computer performance of various devices operating within the communication system 100 (e.g., MHD 110, WAD 120, server 130, and so forth). For example, the performance of the MHD 110 may be improved by one or more of simplifying the communication protocol stack 114 of the MHD 110, improving the throughput of MHD 110 (as well as utilization of wireless communication link 140) by eliminating the need for the transport protocol to send acknowledgment packets over the wireless communication link 140, improving control over transmission of data by MHD 110 via the wireless communication link 140, and so forth. For example, performance of the WAD 120 may be improved by one or more of improving the throughput of WAD 120 (as well as utilization of wireless communication link 140) by eliminating the need for the transport protocol to send acknowledgment packets over the wireless communication link 140, improving control over transmission of data by WAD 120 via wireless communication link 140, and so forth. For example, performance of the server 130 may be improved by one or more of ensuring that the end-to-end transport layer connection does not run over the wireless communication link 140 and so forth. It is noted that embodiments of the networked transport layer socket capability may provide various other improvements in computer performance in supporting communications between devices of communication networks such as communication network 100.

Various embodiments of the networked transport layer socket capability may be configured to provide various other advantages or potential advantages.

As indicated herein, although primarily presented herein with respect to embodiments in which the networked transport layer socket capability is used within the context of wireless network access by a wireless end device (e.g., the end device is a mobile host device, the network access device is a wireless access device, the network communication link is a wireless communication link, and so forth), the networked transport layer socket capability also may be used within the context of wireline access by the end device. Accordingly, various references herein to “mobile host device” may be read more generally as being references to a communication endpoint or a communication device, various references herein to “wireless access device” may be read more generally as being references to a network access device or a network device, and so forth. Various embodiments of the networked transport layer socket capability may be applied in various other contexts to improve communication between devices using transport layer connections.

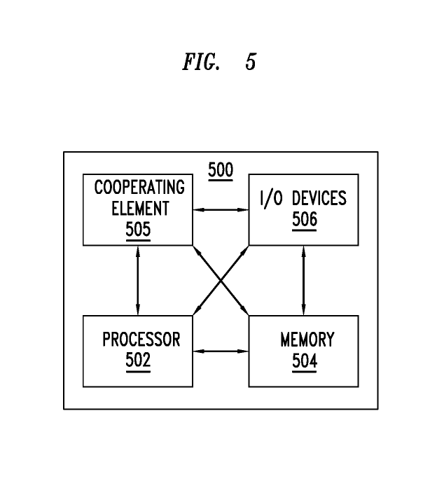

FIG. 5 depicts a high-level block diagram of a computer suitable for use in performing various functions described herein.

The computer 500 includes a processor 502 (e.g., a central processing unit (CPU), a processor having a set of processor cores, a processor core of a processor, or the like) and a memory 504 (e.g., a random access memory (RAM), a read only memory (ROM), or the like). The processor 502 and the memory 504 are communicatively connected.

The computer 500 also may include a cooperating element 505. The cooperating element 505 may be a hardware device. The cooperating element 505 may be a process or set of instructions that can be loaded into the memory 504 and executed by the processor 502 to implement functions as discussed herein (in which case, for example, the cooperating element 505 (including associated data structures) can be stored on a non-transitory computer-readable storage medium, such as a storage device or other storage element (e.g., a magnetic drive, an optical drive, or the like)).

The computer 500 also may include one or more input/output devices 506. The input/output devices 506 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 500 of FIG. 5 may represent a general architecture and functionality suitable for implementing functional elements described herein, portions of functional elements described herein, or the like, as well as various combinations thereof. For example, computer 500 may provide a general architecture and functionality that is suitable for implementing a mobile host device or portion thereof, a communication device or portion thereof, a wireless access device or portion thereof, a network access device or portion thereof, a server or portion thereof, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. A communication device, comprising:
a processor and a memory communicatively connected to the processor, wherein the processor is configured to run a communication protocol stack;
wherein the communication protocol stack includes an application layer, a socket application programming interface (API), a link layer, and a physical layer;
wherein the socket API is configured to support communication of data, between the application layer and a networked transport layer socket hosted on a network access device for the communication device, via the link layer and the physical layer.

2. The communication device of claim 1, wherein the socket API is configured to:
receive, from the application layer, application data intended for a remote device;
include the application data within a primitive message of the socket API; and
provide the primitive message of the socket API to the link layer.

3. The communication device of claim 1, wherein the link layer is configured to:
receive, from the socket API, a primitive message of the socket API, wherein the primitive message of the socket API comprises application data intended for a remote device;
include the primitive message within a link layer data structure of the link layer; and
provide the link layer data structure to the physical layer for transmission toward the network access device via a network communication link.

4. The communication device of claim 1, wherein the link layer is configured to:
receive, from the physical layer, a link layer data structure including a primitive message of the socket API, wherein the primitive message of the socket API includes application data intended for delivery to the application layer;
extract the primitive message of the socket API from the link layer data structure; and
provide the primitive message of the socket API to the socket API.

5. The communication device of claim 1, wherein the socket API is configured to:
receive, from the link layer, a primitive message of the socket API, wherein the primitive message of the socket API includes application data intended for delivery to the application layer;
extract the application data from the primitive message of the socket API; and
provide the application data to the application layer.

6. The communication device of claim 1, wherein the socket API is configured to discover that the network access device is configured to host the networked transport layer socket for the communication device.

7. The communication device of claim 6, wherein, to discover that the network access device is configured to host the networked transport layer socket for the communication device, the socket API is configured to:
access, at the communication device, network capability information received by the communication device in conjunction with attachment of the communication device to the network access device; and
determine, based on the network capability information, that the network access device is configured to host the networked transport layer socket for the communication device.

8. The communication device of claim 6, wherein, to discover that the network access device is configured to support the networked transport layer socket for the communication device, the socket API is configured to:
send, by the socket API toward the network access device, a request for capability information indicative as to whether the network access device is configured to host the networked transport layer socket for the communication device; and
receive, by the socket API from the network access device, the capability information indicative as to whether the network access device is configured to host the networked transport layer socket for the communication device.

9. The communication device of claim 1, wherein the application layer is configured to:
monitor a state of a link layer buffer associated with the link layer; and
control an application data rate of the application layer based on the state of the link layer buffer associated with the link layer.

10. The communication device of claim 1, wherein the socket API is configured to:
detect a mobility event in which the communication device changes from being attached to the network access device to being attached to a new network access device; and
determine, based on the mobility event, whether the new network access device is configured to host the networked transport layer socket for the communication device.

11. The communication device of claim 1, wherein the networked transport layer socket comprises a Transmission Control Protocol (TCP) socket or a User Datagram Protocol (UDP) socket.

12. A method for use by a communication device, the method comprising:
running, by a processor of the communication device, a communication protocol stack, wherein the communication protocol stack includes an application layer, a socket application programming interface (API), a link layer, and a physical layer; and
communicating data, by the socket API between the application layer and a networked transport layer socket hosted on a network access device for the communication device, via the link layer and the physical layer.

13. A network access device, comprising:
a processor and a memory communicatively connected to the processor, wherein the processor is configured to run a communication protocol stack;
wherein the communication protocol stack includes a transport layer, a socket application programming interface (API), a link layer, and a physical layer;
wherein the transport layer is configured to host a networked transport layer socket for a communication device having an application layer;
wherein the socket API is configured to support communication of data, between the networked transport layer socket for the communication device and the application layer of the communication device, via the link layer and the physical layer.

14. The network access device of claim 13, wherein the networked transport layer socket is configured as an endpoint of a transport layer connection, between the network access device and a remote device, for the communication device.

15. The network access device of claim 13, wherein the socket API is configured to:
receive, via a transport layer connection between the networked transport layer socket for the communication device and a remote device, application data intended for the application layer of the communication device;
include the application data within a primitive message of the socket API; and
provide the primitive message of the socket API to the link layer.

16. The network access device of claim 13, wherein the link layer is configured to:
receive, from the socket API, a primitive message of the socket API, wherein the primitive message of the socket API comprises application data intended for the application layer of the communication device;
include the primitive message within a link layer data structure of the link layer; and
provide the link layer data structure to the physical layer for transmission toward the communication device via a network communication link.

17. The network access device of claim 13, wherein the link layer is configured to:
receive, from the physical layer, a link layer data structure including a primitive message of the socket API, wherein the primitive message of the socket API includes application data intended for delivery to a remote device;
extract the primitive message of the socket API from the link layer data structure; and
provide the primitive message of the socket API to the socket API.

18. The network access device of claim 13, wherein the socket API is configured to:
receive, from the link layer, a primitive message of the socket API, wherein the primitive message of the socket API includes application data intended for delivery to a remote device;
extract the application data from the primitive message of the socket API; and
provide the application data to the networked transport layer socket of the communication device.

19. The network access device of claim 13, wherein the socket API is configured to:
receive, from the communication device, a request for capability information indicative as to whether the network access device is configured to host the networked transport layer socket for the communication device; and
send, toward the communication device, the capability information indicative as to whether the network access device is configured to host the networked transport layer socket for the communication device.

20. The network access device of claim 13, wherein the transport layer is configured to:
monitor a state of a link layer buffer associated with the link layer; and
control a data rate of the transport layer based on the state of the link layer buffer associated with the link layer.

21. The network access device of claim 13, wherein the socket API is configured to:
detect a mobility event in which the communication device changes from being associated with the network access device to being associated with a new network access device; and
send, toward the new network access device, data stored in a link layer buffer associated with the link layer.

22. The network access device of claim 13, wherein the networked transport layer socket comprises a Transmission Control Protocol (TCP) socket or a User Datagram Protocol (UDP) socket.

23. The network access device of claim 13, wherein the network access device comprises one of a fourth generation (4G) cellular access device, a fifth generation (5G) cellular access device, or a WiFi access point.

24. A method for use by a network access device, comprising:
running, by a processor of the network access device, a communication protocol stack, wherein the communication protocol stack includes a transport layer, a socket application programming interface (API), a link layer, and a physical layer, wherein the transport layer hosts a networked transport layer socket for a communication device having an application layer; and
communicating data, by the socket API between the networked transport layer socket for the communication device and the application layer of the communication device, via the link layer and the physical layer.
